(19) United States
(12) Patent Application Publication
(10) Pub. No.: US 2023/0316436 A1
(43) Pub. Date: Oct. 5, 2023

(54) METHODS AND INTERNET OF THINGS SYSTEMS FOR SMART GAS PLATFORM WORK ORDER FULFILLMENT

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Yaqiang QUAN, Chengdu (CN)

(73) Assignee: CHENGDU QINCHUAN IOT TECHNOLOGY CO., LTD., Chengdu (CN)

(21) Appl. No.: 18/331,149

(22) Filed: Jun. 7, 2023

(51) Int. Cl. G06Q 50/06; G06Q 10/0631

(52) U.S. Cl. CPC G06Q 50/06; G06Q 10/06315

(57) ABSTRACT

The embodiments of the present disclosure provide a method and Internet of things (IoT) system for smart gas platform work order fulfillment. The method is executed through the IoT system, and the IoT system for smart gas platform work order fulfillment includes a smart gas user platform, a smart gas service platform, a smart gas management platform, a smart gas sensor network platform, and a smart gas object platform. The method is executed by a smart gas management platform, including: obtaining demand information of at least one gas work order of a gas platform, determining, based on the demand information, a fulfillment mode of the at least one gas work order, and in response to that the fulfillment mode is the manual fulfillment, determining a work order fulfillment plan of the at least one gas work order based on the demand information and personnel information of the gas platform.

### TECHNICAL FIELD

The present disclosure relates to the field of Internet of Things (IoT) technology and gas management system, and in particular to a method and an IoT system for smart gas platform work order fulfillment.

### BACKGROUND

With the increasing popularity of a gas use, people's demand for gas-relevant services is also increasing, such as: the demand for a gas maintenance service. If a gas work order corresponding to such service demand is not fulfilled properly and timely, it may affect people's normal life order, or even their personal and property safety, etc.

Aiming at how to determine a fulfillment plan of the gas work order, CN104182821B provides a system and a method for automatically dispatching work orders. The focus of the present disclosure is to obtain a fault work order, analyze work order information according to a business allocation rule, and dispatch the work order. However, the business allocation rule is only to pre-set an issuing unit, and whether the work order is completed, etc., which does not involve specific work order fulfillment personnel and time arrangement.

Therefore, it is hoped to provide a method and IoT system for smart gas platform work order fulfillment, which can analyze the gas work order in a timely manner, determine a reasonable and accurate work order fulfillment plan, facilitate an efficient processing of the gas work order, and effectively improve a user experience.

### SUMMARY

One or more embodiments of the present disclosure provide a method for smart gas platform work order fulfillment. The method is executed through a smart gas management platform of an Internet of things (IoT) system for smart gas platform work order fulfillment, and the method includes: obtaining demand information of at least one gas work order of a gas platform, the demand information including at least one of a demand type, a work order creation time, detection data, a gas component aging degree, gas user feedback information, user information, a demand location, and a demand status; determining, based on the demand information, a fulfillment mode of the at least one gas work order, the fulfillment mode at least including self-service fulfillment and manual fulfillment, the manual fulfillment including at least one of an immediate manual fulfillment and a manual fulfillment after supplementing information I In response to that the fulfillment mode is the manual fulfillment, determining a work order fulfillment plan of the at least one gas work order based on the demand information and personnel information of the gas platform. The work order fulfillment plan includes a fulfillment time limit and fulfillment personnel.

One or more embodiments of the present disclosure provide an IoT system for smart gas platform work order fulfillment. A smart gas management platform of the IoT system is configured to: obtain demand information of at least one gas work order of the gas platform, the demand information including at least one of a demand type, a work order creation time, detection data, a gas component aging degree, gas user feedback information, user information, a demand location and a demand status; determine, based on the demand information, a fulfillment mode of the at least one gas work order, the fulfillment mode at least including a self-service fulfillment and manual fulfillment, and the manual fulfillment including at least one of immediate manual fulfillment and manual fulfillment after supplementing information. I In response to that the fulfillment mode is the manual fulfillment, the smart gas management platform of the IoT system is configured to determine a work order fulfillment plan of the at least one gas work order based on the demand information and personnel information of the gas platform The work order fulfillment plan includes a fulfillment time limit and a fulfillment personnel.

One or more embodiments of the present disclosure provide a non-transitory computer-readable storage medium storing computer instructions. When reading the computer instructions in the storage medium, a computer implements the method for smart gas platform work order fulfillment.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating a platform structure of an Internet of Things (IoT) system for smart gas platform work order fulfillment according to some embodiments of the embodiment;

FIG. 2 is a flowchart illustrating an exemplary method for smart gas platform work order fulfillment according to some embodiments of the present disclosure;

FIG. 3 is a flowchart illustrating an exemplary process for determining a fulfillment mode of at least one gas work order based on demand information according to some embodiments of the present disclosure;

FIG. 4 is a schematic diagram illustrating an exemplary process for determining a fulfillment time limit through a fulfillment time limit prediction model according to some embodiments of the present disclosure; and

FIG. 5 is a flowchart illustrating an exemplary process for determining fulfillment personnel through a preset mode according to some embodiments of the present disclosure.

### DETAILED DESCRIPTION

In order to illustrate the technical solutions of the embodiments of the present disclosure more clearly, the following will briefly introduce the drawings that need to be used in the description of the embodiments. Obviously, the drawings in the following description are only some examples or embodiments of the present disclosure, and those skilled in the art may apply this present disclosure to other similar situations based on these drawings and on the premise of not paying creative labor. Unless obviously obtained from the context or the context illustrates otherwise, the same numeral in the drawings refers to the same structure or operation.

It will be understood that the terms “system,” “device,” “unit,” and/or “module” used herein are one method to distinguish different components, elements, parts, sections, or assemblies of different levels. However, if other words may achieve the same purpose, the words may be replaced by other expressions.

The flowcharts used in the present disclosure illustrate operations that the system implements according to some embodiments of the present disclosure. It should be understood that the foregoing or following operations may not necessarily be performed exactly in order. Instead, various operations may be processed in reverse order or simultaneously. Moreover, one or more other operations may be added into the flowcharts. One or more operations may be removed from the flowcharts.

There are various types of gas work orders, and the specific fulfillment plans corresponding to different gas work orders are also different. CN104182821B only analyzes work order information and dispatches the work orders according to a general business allocation rule, and the business configuration rule is only to pre-set the work orders, issuing units, and whether the work order is completed, etc., which does not involve specific work order fulfillment personnel and time arrangement, let alone how to optimize fulfillment efficiency of the work order and maximize a value of the fulfillment.

Therefore, some embodiments of the present disclosure obtain demand information of at least one gas work order of a gas platform, determine, based on the demand information, a fulfillment mode of the at least one gas work order, and in response to that the fulfillment mode is the manual fulfillment, determine, based on the demand information and personnel information of the gas platform, a work order fulfillment plan of the at least one gas work order. Based on an in-depth analysis of the demand information of the gas work order, some embodiments of the present disclosure reasonably and accurately set a fulfillment time limit and allocate fulfillment personnel to make the processing of the gas work orders timelier and more efficient, thereby optimizing the fulfillment efficiency of the work order and maximizing the value of the fulfillment.

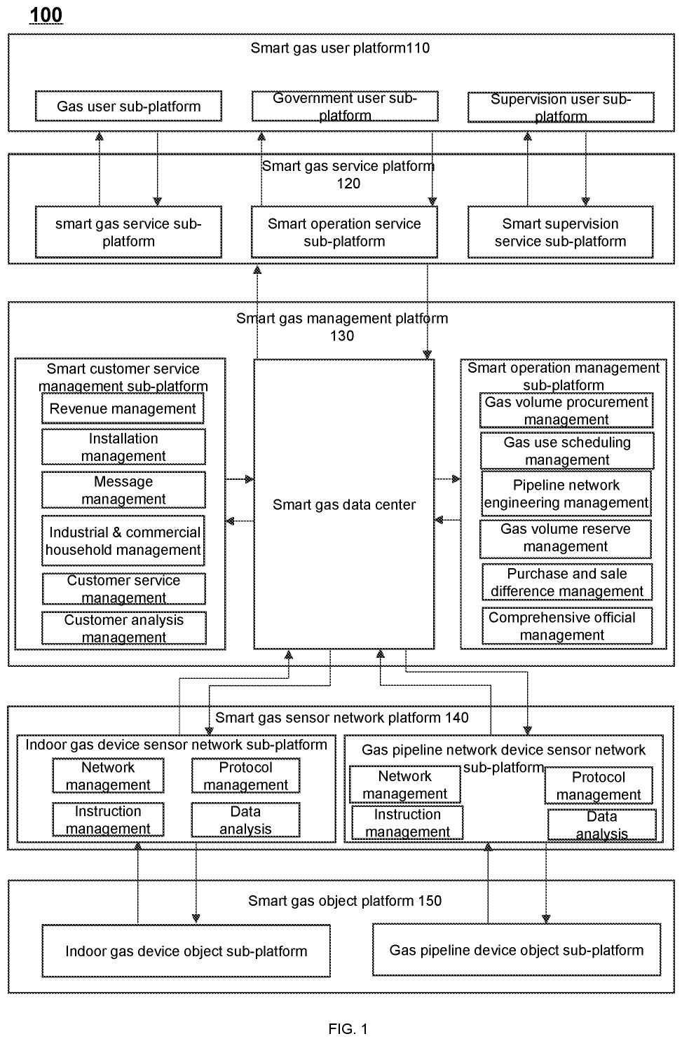

FIG. 1 is a schematic diagram illustrating a platform structure of an Internet of Things (IoT) system for smart gas platform work order fulfillment according to some embodiments of the embodiment.

As shown in FIG. 1, an IoT system 100 for smart gas platform work order fulfillment may include a smart gas user platform 110, a smart gas service platform 120, a smart gas management platform 130, a smart gas sensor network platform 140, and a smart gas object platform 150. A work order fulfillment plan is determined by implementing the IoT system 100 for smart gas platform work order fulfillment disclosed in the present disclosure.

The smart gas user platform 110 may be a platform for interacting with a user. The smart gas user platform 110 may be configured as a terminal device. For example, the terminal device may include a mobile device, a tablet computer, or a combination thereof.

In some embodiments, the smart gas user platform 110 is provided with a gas user sub-platform, a government user sub-platform, and a supervision user sub-platform. The gas user sub-platform is oriented to a gas user, providing information on gas use data and a solution to a gas problem. The gas user refers to a user who uses gas, for example, a commercial gas user, an ordinary gas user, etc. The gas user sub-platform may correspond to and interact with a smart gas service sub-platform to obtain a safe gas use service. The government user sub-platform is oriented to a government user, which provides data relevant to a gas operation. The government user refers to a user of a department relevant to a government gas operation. The government user sub-platform may correspond to and interact with a smart operation service sub-platform to obtain a gas operation service. The supervision user sub-platform is oriented to a supervision user, which supervises an operation of the entire IoT system. The supervision user refers to a user of a safety department. The supervision user sub-platform may correspond to and interact with a smart supervision service sub-platform to obtain a service required by a safety supervision.

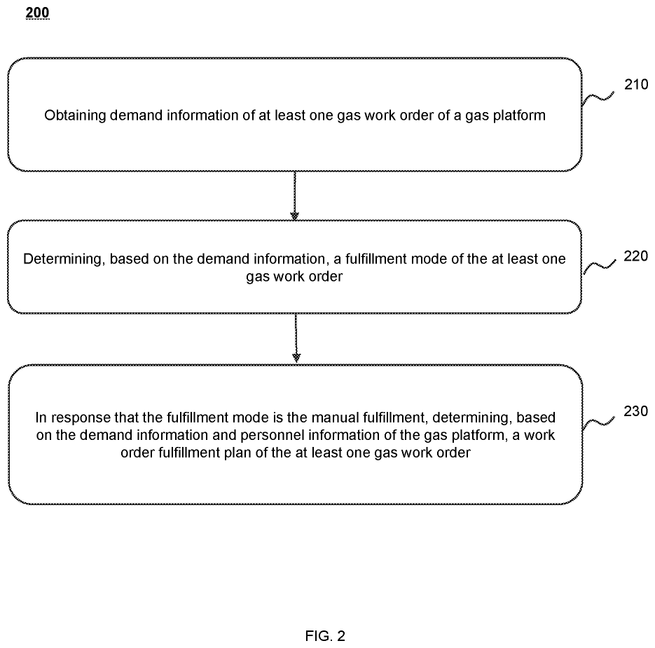

The smart gas user platform 110 may carry out a two-way interaction with the smart gas service platform 120 downwardly, issue gas user feedback information (e.g., a user call) to the smart gas service sub-platform, issue a query instruction for gas operation management information to the smart operation service sub-platform, and receive the gas operation management information uploaded by the smart operation service sub-platform, etc. In some embodiments, the gas operation management information may include a work order fulfillment plan of at least one gas work order. For more information about the work order fulfillment plan, please refer to FIG. 2 and the relevant descriptions.

The smart gas service platform 120 may be a platform for receiving and transmitting data and/or information. The smart gas service platform 120 is provided with a smart gas service sub-platform, a smart operation service sub-platform, and a smart supervision service sub-platform.

The smart gas service platform 120 may interact downwardly with the smart gas management platform 130, issue the query instruction for gas operation management information to a smart gas data center and receive the gas operation management information uploaded by the smart gas data center.

The smart gas management platform 130 refers to a platform for overall planning and coordinating connections and cooperation among various functional platforms, gathering all information of the IoT system, and providing perceptual management and control management functions for the IoT operation system. For example, the smart gas management platform 130 may obtain information about a gas repair problem, etc.

In some embodiments, the smart gas management platform 130 is provided with a smart customer service management sub-platform, a smart operation management sub-platform, and a smart gas data center. Each management sub-platform may perform a two-way interaction with the smart gas data center. The smart gas data center summarizes and stores all operation data of the IoT system, and each management sub-platform may obtain the data from the smart gas data center and feed back the information processed by a relevant management module. For example, the smart gas data center may receive the query instruction for gas operation management information issued by the smart operation service sub-platform and receive the gas user feedback information issued by the smart gas service sub-platform. Each management sub-platform is independent of each other, and the smart gas management platform 130 may exchange information with the smart gas service platform 120 and the smart gas sensor network platform 140, etc., through the smart gas data center.

The smart customer service management sub-platform may be configured for revenue management, installation management, message management, industrial and commercial household management, customer service management, and customer analysis management, etc., and may be configured to view customer feedback information and perform a corresponding reply processing. The smart operation management sub-platform may be configured for gas volume procurement management, gas use scheduling management, pipeline network engineering management, gas volume reserve management, purchase and sale difference management, and comprehensive official management, etc. Through the smart operation management sub-platform, the work order information, personnel arrangement, and working progress of a pipeline network may be checked to implement the pipeline network engineering management.

In some embodiments, the smart gas data center may issue an instruction to obtain relevant data of a gas device to the smart gas sensor network platform 140, and receive the relevant data of the gas device uploaded by the smart gas sensor network platform 140. The relevant data of the gas device may include relevant operation information of the gas pipeline networks of different areas. The smart gas data center may send the feedback information of the gas user and the relevant data of the gas device to the smart operation management sub-platform for processing, and the smart operation management sub-platform may send processed gas operation management information to the smart gas data center. The smart gas data center may send the gas operation management information (e.g., the work order fulfillment plan) to the smart gas service platform 120.

The smart gas sensor network platform 140 may be a functional platform for managing sensor communication. The smart gas sensor network platform 140 may be configured as a communication network and a gateway to realize functions such as network management, protocol management, instruction management, and data analysis.

In some embodiments, the smart gas sensor network platform 140 may include an indoor gas device sensor network sub-platform and a gas pipeline network device sensor network sub-platform, which are respectively relevant to an indoor gas device object sub-platform and a gas pipeline network device object sub-platform, and are respectively configured to obtain relevant data of an indoor device and relevant data of a pipeline network device (both belong to the gas device relevant data).

In some embodiments, the smart gas sensor network platform 140 may be connected to the smart gas management platform 130 and the smart gas object platform 150 to realize the functions of perceptual information sensor communication and control information sensor communication. For example, the smart gas sensor network platform 140 may interact with the smart gas object platform 150 downwardly, receive the relevant data of the gas device uploaded by the smart gas object platform 150, and issue the instruction to obtain the relevant data of the gas device to the smart gas object platform 150. The smart gas sensor network platform 140 may further interact with the smart gas management platform 130 upwardly, receive the instruction issued by the smart gas data center to obtain the relevant data of the gas device, and upload the relevant data of the gas device to the smart gas data center.

The smart gas object platform 150 may be a functional platform for generating perception information and executing controlling information and may include various types of devices such as the gas device and other devices. The gas device may be a variety of devices that may fail. The gas device may include an indoor device and a pipeline network device. The pipeline network device may include a gas gate station compressor, a gas flow meter, a valve control device, etc. In some embodiments, the other devices may include a monitoring device, a temperature sensor, a pressure sensor, etc.

In some embodiments, the smart gas object platform 150 may further be provided with an indoor gas device object sub-platform and a gas pipeline network device object sub-platform. The indoor gas device object sub-platform may include the indoor device. The gas pipeline network device object sub-platform may include the pipeline network device.

In some embodiments, the smart gas object platform 150 may interact upwardly with the smart gas sensor network platform 140. For example, the smart gas object platform 150 may obtain at least one of detection data and a gas component aging degree, and transmit the at least one to the smart gas management platform 130 through the smart gas sensor network platform 140.

Through a closed-loop management formed by an IoT functional architecture of the five platforms, informatization and intelligence are realized. Through a detailed and clear division of labor of the platforms, a waiting cost of the user is reduced, efficiency of the problem handling is improved, and the information processing of the IoT is smoother and more efficient.

FIG. 2 is an exemplary flow chart illustrating a method smart gas platform work order fulfillment according to some embodiments of the present disclosure. In some embodiments, a process 200 may be executed by the smart gas management platform. As shown in FIG. 2, the process 200 includes the following operations.

In 210, obtaining demand information of at least one gas work order of a gas platform.

The gas platform refers to a platform that provides a user with a gas-relevant service and implements a function of the gas-relevant service. For example, the gas platform may include five platforms including the smart gas user platform in the Internet of things (IoT) system for smart gas platform work order fulfillment in FIG. 1.

The gas work order refers to a work basis for a pending task generated according to a gas service demand. For example, the gas work order may be a gas maintenance work order, a gas meter reading work order, etc.

The demand information may refer to information relevant to the gas service demand. In some embodiments, the demand information may include at least one of a demand type, a work order creation time, detection data, a gas component aging degree, gas user feedback information, user information, a demand location, and a demand status, etc.

The demand type refers to a type of the gas service demand. For example, the demand type may include a gas migration type, a gas failure maintenance type, etc.

The work order creation time refers to a time when the gas work order is created.

The detection data refers to a detected parameter relevant to the gas, for example, a parameter relevant to a gas device, a gas use volume, etc.

The gas component aging degree refers to a parameter that indicates a degree of performance degradation of the gas component, such as the aging degree of a gas hose and a gas meter.

The gas user feedback information refers to information relevant to the gas service demand fed back by the user, for example, a failure status of the gas device fed back by the gas user and relevant images of the failed gas device submitted by the gas user.

The user information refers to information relevant to the gas user, for example, a gas user age, a gas user count, a gas user type, etc. The type of the gas user refers to different types of gas user, for example, a business user, a residential user, etc.

The demand location refers to a location where the user needs the service relevant to gas.

The demand status refers to a completion status of the user's gas service demand. For example, the demand status may be a fulfillment mode to be allocated status, an information to be supplemented status, a fulfilled status, etc.

In some embodiments, the smart gas management platform may obtain the demand information of the gas work order of the gas platform in various ways. For example, the smart gas management platform may obtain the demand information through a government user sub-platform, a gas user input, and a storage device inside or outside the IoT system.

In some embodiments, the smart gas object platform may be configured to obtain at least one of the detection data and the gas component aging degree, and transmit the at least one to the smart gas management platform through the smart gas sensor network platform. The smart gas user platform is configured to obtain at least one of the demand type, the work order creation time, the gas user feedback information, the user information, the demand location, and the demand status, and transmit the at least one to the smart gas management platform through the smart gas service platform.

In 220, determining, based on the demand information, a fulfillment mode of the at least one gas work order.

The fulfillment mode refers to a mode type for fulfilling the gas work order. In some embodiments, the fulfillment mode may at least include self-service fulfillment and manual fulfillment.

The self-service fulfillment refers to the self-service fulfillment of the gas work order. For example, the self-service fulfillment may be terminal automatic fulfillment by the gas user or the gas platform. For example, a certain gas work order is completed by the gas user through a guidance of the client and technical personnel. As another example, the self-service fulfillment may be that the smart gas object platform obtains gas-relevant data through the gas device such as a gas flow meter.

The manual fulfillment refers to fulfillment of the gas work order by human participation. For example, a certain gas maintenance work order may be manually maintained by fulfillment personnel of the gas platform.

In some embodiments, the manual fulfillment may include at least one of immediate manual fulfillment and manual fulfillment after supplementing information.

The immediate manual fulfillment refers to that the manual fulfillment may be performed on the gas work order. For example, the immediate manual fulfillment may be dispatching fulfillment personnel to fulfill the gas work order.

The manual fulfillment after supplementing information refers to the manual fulfillment of the gas work order after a completion of a demand information supplement.

In some embodiments, the smart gas management platform may determine the fulfillment mode of the gas work order in various ways based on the demand information. For example, the smart gas management platform may determine the fulfillment mode of the gas work order through the result of a manual selection. As another example, the smart gas management platform may determine the fulfillment mode of the gas work order through historical data. For example, the smart gas management platform may construct a historical demand information vector based on demand information of a historical gas work order, construct a current demand information vector according to demand information of a current gas work order, and calculate a distance between the current demand information vector and the historical gas demand information vector, if the distance is less than a first preset threshold, it may be determined that the fulfillment mode of the historical gas work order is the fulfillment mode of the current gas work order.

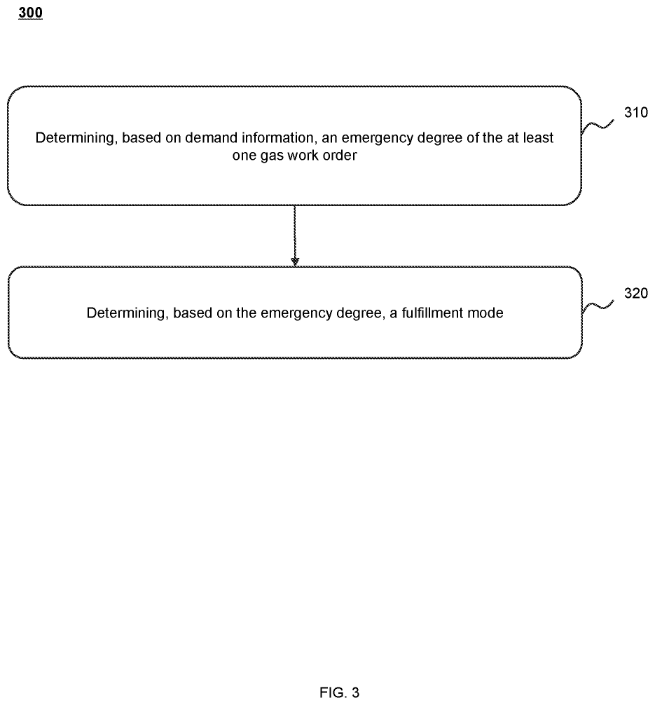

In some embodiments, the smart gas management platform may determine, based on the demand information, an emergency degree of the at least one gas work order; and determine, based on the emergency degree, the fulfillment mode. For more about the above contents, please refer to FIG. 3 and the relevant descriptions.

In 230, in response to that the fulfillment mode is the manual fulfillment, determining, based on the demand information and personnel information of the gas platform, a work order fulfillment plan of the at least one gas work order.

The personnel information of the gas platform refers to the relevant information of personnel in the gas platform who is capable of processing the gas work order. For example, the personnel information of the gas platform may be a count of processing personnel, free time of the processing personnel, etc.

In some embodiments, the smart gas management platform may obtain the personnel information of the gas platform in various ways. For example, the smart gas management platform may obtain the personnel information through a government user sub-platform, a supervision user sub-platform, a storage device inside or outside the system, etc.

The work order fulfillment plan refers to a specific fulfillment plan content such as the fulfillment personnel and a fulfillment time limit of a plurality of gas work orders.

In some embodiments, the work order fulfillment plan may include the fulfillment personnel and the fulfillment time limit.

The fulfillment time limit refers to a time limit requirement for the fulfillment personnel to fulfill the gas work order. In some embodiments, the fulfillment time limit may be a specific time range, a deadline, a time period from the current time, etc.

The fulfillment personnel refers to one or more processing personnel who fulfills the gas work order.

In some embodiments, the smart gas management platform may determine the work order fulfillment plan of the at least one gas work order in various ways based on the demand information and the personnel information of the gas platform. For example, the smart gas management platform may determine the work order fulfillment plan of the at least one gas work order based on a result manually input by gas platform personnel. As another example, the smart gas management platform may determine the work order fulfillment plan of the at least one gas work order through the historical data. For a specific mode of determining the work order fulfillment plan of the at least one gas work order through the historical data, please refer to the aforementioned mode of determining the fulfillment mode of the gas work order through the historical data.

In some embodiments, the smart gas management platform may determine a gas pipeline network complexity based on a pipeline branch point count, a gas user type, a gas user count, and a pipeline density of a gas pipeline network of an area where the demand location is located; and determine the fulfillment time limit based on the demand type, the detection data, the gas component aging degree, the user information, and the gas pipeline network complexity.

The pipeline branch point count refers to a count of intersections of different pipelines of the gas pipeline network in the area where the demand location is located.

The gas user type refers to different types of the gas users, for example, a residential user, an industrial user, etc.

The gas user count refers to a count of households of the gas users.

The pipeline density refers to a parameter that indicates a density of a gas pipeline distribution. In some embodiments, the pipeline density may be represented by a ratio of a total length of the gas pipelines in an area where the demand location corresponding to the gas work order is located to an acreage of the area. For example, the demand location corresponding to a certain gas work order is Community B, the corresponding pipeline density may be the ratio of the total length of the gas pipelines in Community B to the acreage of Community B.

The gas pipeline network complexity refers to a parameter that may indicate the complexity of a gas pipeline distribution in the gas pipeline network. In some embodiments, the gas pipeline network complexity may be indicated by quantitative indicators. For example, the gas pipeline network complexity may be indicated by a number between 1-10, and the greater the number is, the higher the gas pipeline network complexity is. In some embodiments, the gas pipeline network complexity may further be expressed in other ways.

In some embodiments, the smart gas management platform may determine a gas pipeline network complexity in various ways based on the pipeline branch point count, the gas user type, the gas user count and the pipeline density of a gas pipeline network of an area where the demand location is located. For example, the smart gas management platform may determine the gas pipeline network complexity based on a result manually input by the gas platform personnel. As another example, the smart gas management platform may determine the gas pipeline network complexity through a first preset rule. The first preset rule refers to a preset rule for determining the gas pipeline network complexity. The first preset rule may be determined based on experience.

In some embodiments, the smart gas management platform may set the first preset rule relevant to the pipeline branch point count, the gas user type, the gas user count, the pipeline density of the gas pipeline network, and take an average value of the gas pipeline network complexity obtained according to each first preset rule as the gas pipeline network complexity in the area where the demand location is located.

In some embodiments, the fulfillment time limit may include at least one of a latest start time and a latest completion time of the at least one gas work order. The latest start time refers to a latest fulfillment start time at which the gas work order may be normally performed. The latest completion time refers to a latest fulfillment end time at which the gas work order may be normally performed.

In some embodiments, the user information includes at least one of a gas user type, a gas customer count, and a gas customer feature. For more contents on the gas user type, please refer to the relevant descriptions above. The gas customer count refers to a count of customers corresponding to the gas users.

The gas customer feature refers to information relevant to features of the gas customers, for example, an age distribution of the gas customers, etc.

In some embodiments, the smart gas management platform may determine the fulfillment time limit in various ways based on the demand type, the detection data, the gas component aging degree, the user information, and the gas pipeline network complexity. For example, the smart gas management platform may determine the fulfillment time limit based on the results manually input by the gas platform working personnel. As another example, the smart gas management platform may construct a first vector based on the demand type, the detection data, the gas component aging degree, the user information, and the gas pipeline network complexity, and determine a first reference vector whose similarity with the first vector is greater than a second preset threshold through retrieving a vector database. A weighted sum is performed on historical fulfillment time limits corresponding to the first reference vectors to determine the fulfillment time limit. The second preset threshold and a sum weight may be set based on experience.

The first reference vector may be constructed based on the demand type, the detection data, the gas component aging degree, the user information, and the gas pipeline network complexity of the gas work order with a high user feedback satisfaction in a historical gas work order fulfillment record. The similarity refers to a degree of similarity between the first vector and the reference vector. In some embodiments, the smart gas management platform may calculate the distance between the first vector and the first reference vector, and determine the similarity based on the vector distance. The similarity may be represented by a numerical value, for example, the similarity is 80%.

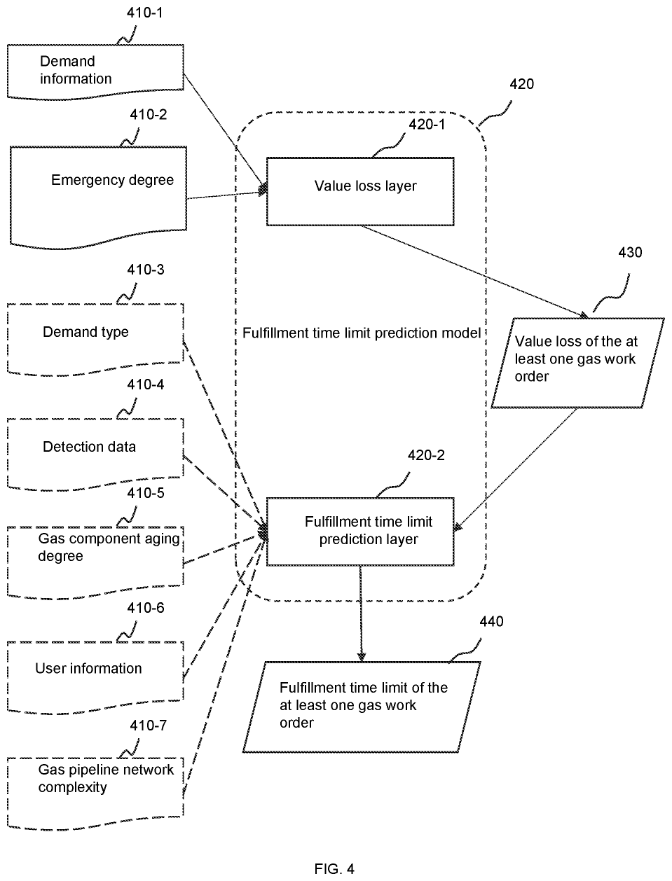

In some embodiments, the smart gas management platform may determine the fulfillment time limit through a fulfillment time limit prediction model based on the demand type, the detection data, the gas component aging degree, the user information, and the gas pipeline network complexity. For more about the above contents, please refer to FIG. 4 and its relevant descriptions.

By determining the gas pipeline network complexity, and then determining the fulfillment time limit based on the demand information and the gas pipeline network complexity, the influence of various influencing factors on the fulfillment time limit may be considered at the same time, and a more accurate fulfillment time limit of the gas work order that is more in line with the actual gas service demand may be determined.

In some embodiments, the smart gas management platform may determine the fulfillment personnel based on the demand information and the personnel information of the gas platform. The fulfillment personnel includes at least one of a fulfillment individual and a fulfillment team who fulfill the at least one gas work order, and the personnel information at least includes a proficiency degree of processing personnel and the pending work order information of the processing personnel.

The fulfillment individual refers to a single individual who fulfills the gas work order. The fulfillment team refers to a team of at least two individuals who fulfill the gas work order.

The proficiency degree of the processing personnel refers to a parameter indicating a proficiency degree of the processing personnel in processing the gas work order. The proficiency degree of the processing personnel may be indicated by a quantitative indicator. For example, the proficiency degree of the processing personnel may be indicated by a number between 1-10, and the greater the number is, the higher the proficiency degree of the processing personnel is. The proficiency degree of the processing personnel may further be expressed in other ways.

In some embodiments, the proficiency degree of the processing personnel is relevant to a personnel rank, a historical gas work order count corresponding to the processing personnel, and a historical gas work order type distribution. The higher the personnel rank is, the greater the historical gas work order count corresponding to the processing personnel is, the more gas fault types processed in the historical gas work order type distribution processed by the personnel are, and the more average the gas fault types are, the higher the proficiency degree of the processing personnel is.

The personnel rank refers to a level corresponding to the personnel position, and the level may include junior maintenance personnel, senior maintenance personnel, etc.

The historical gas work order count refers to a count of gas work orders processed by the processing personnel in the historical time, and the historical time may be preset.

The historical gas work order type distribution refers a distribution of different types of historical gas work orders. For example, the historical gas work order type distribution of certain processing personnel may include 15 historical gas maintenance work orders, 20 historical gas meter reading work orders, etc.

In some embodiments, the smart gas management platform may obtain the personnel rank, the historical gas work order count corresponding to the processing personnel, and the historical gas work order type distribution through internal or external storage devices of the IoT system, etc.

In some embodiments, the smart gas management platform may obtain the proficiency degree of the processing personnel in various ways. For example, the smart gas management platform may determine the proficiency degree of the processing personnel through the result manually input by the gas platform personnel. As another example, the smart gas management platform may determine the proficiency degree of the processing personnel through a second preset rule. The second preset rule refers to a preset rule for determining the proficiency degree of the processing personnel. The second preset rule may be determined based on experience. Specifically, for the mode of determining the proficiency degree of the processing personnel through the second preset rule, reference may be made to the aforementioned mode of determining the gas pipeline network complexity through the first preset rule.

The pending work order information of the processing personnel refers to information relevant to the gas work orders distributed to the processing personnel but not yet fulfilled, for example, a fulfillment time limit of the pending work order of the processing personnel, a count of pending work orders of the processing personnel, etc.

In some embodiments, the smart gas management platform may obtain the pending work order information of the processing personnel through the internal or external storage devices of the IoT system for smart gas platform work order fulfillment.

In some embodiments, the smart gas management platform may determine the fulfillment personnel in various ways based on the demand information and the personnel information of the gas platform. For example, the smart gas management platform may select a staff who has the least count of the pending work orders before the fulfillment time limit of a certain gas work order and whose proficiency degree meets the fulfillment demand of the gas work order as the fulfillment personnel. For example, the count of pending work orders of the processing personnel 1-3 is 2, 4, and 5, respectively, the proficiency degree of the processing personnel 1-3 is 4, 5, and 6, respectively, and a proficiency degree fulfillment demand of a gas work order A is 5, then the processing personnel 2 is selected as the fulfillment personnel.

As another example, the smart gas management platform may construct a second vector based on the demand information and the personnel information of the gas platform, and determine a second reference vector whose similarity with the second vector is greater than a third preset threshold by searching the vector database. The historical fulfillment personnel corresponding to the second reference vector is taken as determined fulfillment personnel. The third preset threshold may be set based on experience. The second reference vector may be constructed based on the demand information and the personnel information of the gas platform with a high user feedback satisfaction in a historical gas work order fulfillment record. The similarity refers to a degree of similarity between the second vector and the second reference vector. In some embodiments, the smart gas management platform may calculate the distance between the second vector and the second reference vector, and determine the similarity based on the vector distance. The similarity may be indicated by a numerical value, for example, the similarity is 60%.

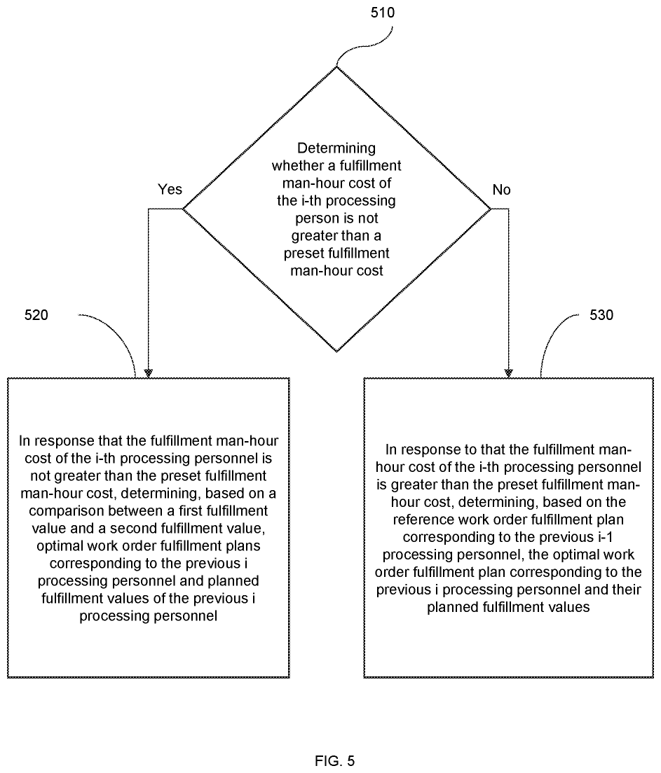

In some embodiments, the smart gas management platform may determine the fulfillment personnel through a preset mode based on the demand information and the personnel information of the gas platform. For more details about determining the fulfillment personnel through the preset method, please refer to FIG. 5 and relevant descriptions.

By obtaining the personnel information of the gas platform, and then determining the fulfillment personnel based on the demand information and the personnel information of the gas platform, the influence of multiple influencing factors on the fulfillment personnel may be considered at the same time, and gas work order fulfillment personnel who is more in line with the actual gas service needs of the user can be determined more accurately.

By obtaining the demand information of the gas work order, determining the fulfillment mode of the gas work order, and then determining the work order fulfillment plan, an accurate work order fulfillment plan can be provided in combination with the user's actual gas service demand, thereby shortening a determination time, saving labor costs, and improving processing efficiency and improve the user experience.

FIG. 3 is a flowchart illustrating an exemplary process for determining a fulfillment mode of at least one gas work order based on demand information according to some embodiments of the present disclosure. In some embodiments, a process 300 may be executed by the smart gas management platform 130.

In 310, determining, based on demand information, an emergency degree of at least one gas work order.

The emergency degree refers to a parameter reflecting the urgency of an event. In some embodiments, the emergency degree may be represented by texts, numbers, percentages, etc. For example, the text representation may include a “slight grade”, a “general grade”, a “major grade” etc.

The smart gas management platform 130 may determine the emergency degree of the at least one gas work order in various ways based on the demand information. For example, the smart gas management platform 130 may determine the emergency degree of the gas work order based on a manually input result. As another example, the smart gas management platform 130 may determine the emergency degree of the gas work order according to a third preset rule. The third preset rule refers to a preset rule for determining the emergency degree. The third preset rule may be determined based on experience. For a specific mode of determining the emergency degree through the third preset rule, please refer to the aforementioned mode of determining the gas pipeline network complexity through the first preset rule.

In 320, determining, based on the emergency degree, a fulfillment mode.

In some embodiments, the smart gas management platform 130 may determine the fulfillment mode of the gas work order in various ways based on the emergency degree. The emergency degree may be represented by a number from “1-10”, the greater the number is, the higher the corresponding emergency degree is. When the emergency degree exceeds a fourth preset threshold or is within a preset range, the smart gas management platform 130 may set the fulfillment mode of the gas work order as manual fulfillment; when the emergency degree is not greater than the fourth preset threshold or is not within the preset range, the smart gas management platform 130 may set the fulfillment mode of the gas work order as self-service fulfillment. For more information about the fulfillment mode, please refer to FIG. 2 and the relevant descriptions.

Through determining the emergency degree of the at least one gas work order based on the demand information, and then determining the fulfillment mode of the gas work order based on the emergency degree, an accurate work order fulfillment plan based on the user's actual gas service demand can be provided, thereby shortening a duration of determining the work order fulfillment, saving the labor costs, improving the processing efficiency of the gas work orders, and improving gas service experience of the user.

In some embodiments, in response to that the fulfillment mode is the manual fulfillment, the smart gas management platform 130 may determine that the at least one gas work order adopts immediate manual fulfillment or manual fulfillment after supplementing information based on an information adequacy. Please refer to FIG. 2 for more contents on the immediate manual fulfillment and the manual fulfillment after supplementing information.

The information adequacy refers to comprehensiveness of the demand information. In some embodiments, the information adequacy may be represented by texts, numbers, percentages, etc. For example, a text representation may include “high”, “medium”, “low”, etc.

In some embodiments, the smart gas management platform 130 may determine the information adequacy of the gas work order in various ways based on the demand information of the gas work order. For example, the smart gas management platform 130 may determine the information adequacy of the gas work order based on the demand information included in the gas work order. Merely by way of example, if a total demand information is 10 items, and a gas work order C only includes 6 items of the demand information, the information adequacy of the gas work order C is 60%.

In some embodiments, the smart gas management platform 130 may further determine whether the manual fulfillment mode of the gas work order is the immediate manual fulfillment or the manual fulfillment after supplementing information based on the information adequacy. For example, when the information adequacy is “high”, the smart gas management platform 130 may set the fulfillment mode of the gas work order as the immediate manual fulfillment; and when the information sufficiency is “low”, the smart gas management platform 130 may set the fulfillment mode of the gas work order as the manual fulfillment after supplementing information.

In response to that the fulfillment mode of the gas work order is the manual fulfillment, by further determining, based on the information adequacy, whether the fulfillment mode of the gas work order is the immediate manual fulfillment or the manual fulfillment after supplementing information, a completeness and accuracy of the demand information is ensured, and by adopting a matched gas work order fulfillment mode to process the gas work orders, the processing efficiency of the gas work order and the user satisfaction are further improved.

In some embodiments, the information sufficiency is relevant to a correction coefficient, and the smart gas management platform 130 may determine the correction coefficient based on the gas pipeline network complexity. For example, the information adequacy after correction may be a product of the information adequacy before correction and the correction coefficient. Please refer to FIG. 2 for more contents on the gas network complexity.

The correction coefficient refers to a coefficient for partially adjusting and correcting the information adequacy when there is a deviation in the information adequacy. In some embodiments, the correction coefficient may be represented by numbers, etc. For example, the correction coefficient may be represented by a certain number in “0.5-1.5”. The correction coefficient may further include other representations.

The smart gas management platform 130 may determine the correction coefficient in various ways based on the gas pipeline network complexity. For example, the correction coefficient may be negatively relevant with the gas pipeline network complexity, that is, the higher the gas pipeline network complexity is, the smaller the corresponding correction coefficient is. As another example, the smart gas management platform 130 may set a plurality of fifth preset rules relevant to the gas pipeline network complexity and the correction coefficient, and use the average value of the correction coefficients obtained according to the fifth preset rules as the correction coefficient of the information adequacy.

By determining the correction coefficient based on the gas pipeline network complexity, and then correcting the information adequacy based on the correction coefficient, the influence of different gas pipeline network complexity on the information adequacy is comprehensively considered, so as to avoid an occurrence of a great deviation between the information adequacy and the actual situation. In this way, the accuracy of the information adequacy is improved to ensure that the gas work orders are processed adopting a matched work order fulfillment mode, which further improves the processing efficiency of the gas work orders and the user satisfaction.

FIG. 4 is a schematic diagram illustrating an exemplary process for determining a fulfillment time limit through a fulfillment time limit prediction model according to some embodiments of the present disclosure.

In some embodiments, the smart gas management platform 130 may determine, based on a demand type 410-3, detection data 410-4, a gas component aging degree 410-5, user information 410-6 and a gas pipeline network complexity 410-7, the fulfillment time limit.

In some embodiments, a fulfillment time limit prediction model 420 may be a model for determining the fulfillment time limit of a gas work order. The fulfillment time limit prediction model 420 may be a machine learning model. For example, the fulfillment time limit prediction model 420 may be a neural network model, a deep neural network, etc., or any combination thereof.

In some embodiments, an input of the fulfillment time limit prediction model 420 may include the demand type 410-3, the detection data 410-4, the gas component aging degree 410-5, the user information 410-6, and the gas pipeline network complexity 410-7, and an output of the fulfillment time limit prediction model 420 may include the fulfillment time limit. Please refer to FIG. 2 and its relevant descriptions for more information about the demand type, the test data, the gas component aging degree, the user information, the gas pipeline network complexity, and the fulfillment time limit.

In some embodiments, the fulfillment time limit prediction model 420 may be obtained by training a plurality of first training samples with labels. The plurality of first training samples with labels may be input to an initial fulfillment time limit prediction model, a loss function is constructed through the labels and the output of the initial fulfillment time limit prediction model, and a parameter of the initial fulfillment time limit prediction model is iteratively updated based on the loss function. When the loss function of the initial fulfillment time limit prediction model satisfies a set condition, the model training is completed, and a trained fulfillment time limit prediction model 420 is obtained. The set condition may include one or more of the loss functions being smaller than a threshold, converging, or the training period reaching a threshold.

In some embodiments, the first training sample may include the demand type, the detection data, the gas component aging degree, the user information, and the gas pipeline network complexity of a sample gas work order. The label may include a sample fulfillment time limit of the sample gas work order. The sample fulfillment time limit is a time limit satisfying a certain demand, for example, the time limit less than a certain threshold. In some embodiments, the first training sample may be obtained based on historical data. The label of the first training sample may be obtained through manual labeling.

By generating the fulfillment time limit of at least one gas work order based on the fulfillment time limit prediction model 420, the fulfillment time limit of the gas work order can be more accurately determined in combination with the actual situation, thereby reducing a labor cost and waste of resource required for manual evaluation and determination.

In some embodiments, the input of the fulfillment time limit prediction model 420 may further include an emergency degree 410-2 of the at least one gas work order. For more contents about the emergency degree, please refer to FIG. 3 and the relevant descriptions.

In some embodiments, when the input of the fulfillment time limit prediction model 420 includes the emergency degree 410-2 of the at least one gas work order, the first training sample may further include the emergency degree of the sample gas work order.

The fulfillment time limit prediction model 420 comprehensively considers the demand type 410-3, the detection data 410-4, the gas component aging degree 410-5, the user information 410-6, the gas pipeline network complexity 410-7, and the emergency degree 410-2 of the gas work order to determine the fulfillment mode of the gas work order, which provides an accurate work order fulfillment plan based on the user's actual gas service demand, shortens the time for determining the work order fulfillment plan, saves the labor costs, improves the processing efficiency of the gas work order, and improves the user's gas service experience.

In some embodiments, the fulfillment time limit prediction model 420 may include a value loss layer 420-1 and a fulfillment time limit prediction layer 420-2.

In some embodiments, the smart gas management platform 130 may determine a value loss 430 of the at least one gas work order through value loss layer 420-1 based on the demand information 410-1 and the emergency degree 410-2. The smart gas management platform 130 may determine, based on the value loss 430, the demand type 410-3, the detection data 410-4, the gas component aging degree 410-5, the user information 410-6, and the gas pipeline network complexity 410-7 of the at least one gas work order, the fulfillment time limit 440 of the at least one gas work order through the fulfillment time limit prediction layer 420-2. For more information about the demand information, the demand type, the detection data, the gas component aging degree, the user information, and the gas pipeline network complexity, please refer to FIG. 2 and the relevant descriptions. For more information about the emergency degree, please refer to FIG. 3 and the relevant descriptions.

The value loss layer 420-1 may be configured to determine the value loss of the at least one gas work order. In some embodiments, an input of the value loss layer 420-1 may include the demand information 410-1 and the emergency degree 410-2 of the at least one gas work order, and an output may include the value loss 430 of the at least one gas work order. In some embodiments, the value loss layer 420-1 may be a machine learning model. For example, the value loss layer 420-1 may be a model such as a convolutional neural network (CNN), a recurrent neural network (RNN).

The value loss 430 of the at least one gas work order refers to a loss caused when the demand of the gas work order is not met. For example, a service quality loss, a cost loss, etc. In some embodiments, the service quality loss may be determined based on an on-time delivery rate, a work order wrong delivery rate, a user complaint rate, etc. The cost loss may be determined based on an actual property loss and a user compensation loss caused to the user when the demand of the gas work order is not met.

The fulfillment time limit prediction layer 420-2 may be configured to determine the fulfillment time limit 440 of the at least one gas work order. In some embodiments, the input of the fulfillment time limit prediction layer 420-2 may include the demand type 410-3, the detection data 410-4, the gas component aging degree 410-5, the user information 410-6, the gas pipeline network complexity 410-7, and the value loss 430 of the at least one gas work order, and the output of the fulfillment time limit prediction layer 420-2 may include the fulfillment time limit 440 of the at least one gas work order. In some embodiments, the fulfillment time limit prediction layer 420-2 may be a machine learning model. For example, the fulfillment time limit prediction layer 420-2 may be a model such as a CNN, a RNN, etc.

In some embodiments, the value loss layer 420-1 and the fulfillment time limit prediction layer 420-2 may be obtained through a joint training based on second training samples and labels of the second training samples. For example, the demand information and the emergency degree of the second training sample gas work order are input to the value loss layer 420-1 to obtain the value loss of the sample gas work order output by the value loss layer 420-1; and the value loss of the sample gas work order output by the value loss layer 420-1 and the demand type, the detection data, the gas component aging degree, the user information, and the gas pipeline network complexity corresponding to the second training sample gas work order are input into the fulfillment time limit prediction layer 420-2 to obtain the sample fulfillment time limit output by the fulfillment time limit prediction layer 420-2.

The label of the second training sample may be obtained based on the sample fulfillment time limit corresponding to the demand type, the detection data, the gas component aging degree, the user information, and the gas pipeline network complexity of the sample gas work order in the historical data. The sample fulfillment time limit is the time limit meeting a certain requirement, for example, the time limit less than a certain threshold. During a training process, the fulfillment time limit prediction model 420 may construct a loss function based on the label and an output result of the fulfillment time limit prediction layer 420-2. At the same time, the fulfillment time limit prediction model 420 may update the parameter of the value loss layer 420-1 and the fulfillment time limit prediction layer 420-2 until the set condition is met and the training is completed. The set condition may include one or more of the loss function being smaller than a threshold, converges, or the training period reaches a threshold.

By processing the information of the at least one gas work order through the fulfillment time limit prediction model 420 including the value loss layer 420-1 and the fulfillment time limit prediction layer 420-2 to obtain the fulfillment time limit of the gas work order, a problem of difficult to obtain the accurate fulfillment time limit when the value loss layer 420-1 is trained separately may be solved more smoothly. By jointly training the value loss layer 420-1 and the fulfillment time limit prediction layer 420-2, the count of required samples may be reduced, and the training efficiency may be improved.

FIG. 5 is a flowchart illustrating an exemplary process for determining fulfillment personnel through a preset mode according to some embodiments of the present disclosure.

In some embodiments, the smart gas management platform may determine the fulfillment personnel through the preset mode based on demand information and personnel information of a gas platform. For more information about the demand information, the personnel information of the gas platform, and the fulfillment personnel, please refer to FIG. 2 and the relevant descriptions.

The preset mode refers to a preset mode of determining the fulfillment personnel. In some embodiments, the preset mode may be to sort a free time of the processing personnel and a proficiency degree of the processing personnel, and select the processing personnel with the highest comprehensive ranking of the free time and proficiency degree before the gas work order fulfillment time limit as the fulfillment personnel.

In some embodiments, the smart gas management platform may determine preferred fulfillment personnel in an optimal work order fulfillment plan corresponding to previous i count of processing personnel as the fulfillment personnel.

The previous i count of processing personnel refer to the i count of processors before any processor. A value of i may be a natural number, for example, 1, 2, 3 . . . etc. The i may start taking value from the maximum value n. The maximum value n of the i may be the count of the processing personnel. The processing personnel are personnel who meet the demands such as a time arrangement and the personnel information.

The optimal work order fulfillment plan refers to the best work order fulfillment plan selected from various feasible work order fulfillment plans in accordance with a principle of a comparative merit. For example, the optimal work order fulfillment plan may be the plan with the greatest planned fulfillment value and the least fulfillment man-hour cost among the work order fulfillment plans. The preferred fulfillment personnel refers to the processing personnel corresponding to the optimal work order fulfillment plan. For more contents on the planned fulfillment value, please refer to the relevant descriptions later in FIG. 5.

In some embodiments, a determination of the fulfillment personnel in the preset mode is relevant to the fulfillment value of the processing personnel.

The fulfillment value may be benefits such as an improvement of a customer experience and an economic income brought by the processing personnel's fulfillment of the gas work orders. Different processing personnel perform different gas work orders, and the corresponding fulfillment values are different. In some embodiments, the fulfillment value is relevant to the proficiency degree of the processing personnel, the emergency degree, and the value loss of each gas work order, etc.

In some embodiments, the fulfillment value is positively relevant with the proficiency degree of the processing personnel and a severity degree of the gas work order, and negatively relevant with the value loss. The higher the proficiency degree of the processing personnel is, the higher the severity degree of the gas work order is, and the lower the value loss is, the higher the fulfillment value is. In some embodiments, the smart gas management platform may determine the fulfillment value in a mode similar to the aforementioned mode of determining the gas pipeline network complexity. For more contents about the proficiency degree of the processing personnel, the emergency degree, and the value loss, please refer to the relevant descriptions in FIGS. 2-4.

By setting the determination of the fulfillment personnel in the preset mode to be relevant to the fulfillment value of the processing personnel, it is possible to match the fulfillment personnel with a relatively high fulfillment value for the gas work order to achieve a reasonable planning of human resources. In addition, the processing personnel proficiency, the emergency degree, and the value loss of the work order are relevant to the fulfillment value of the processing personnel. As a result, a balance of the three may be fully considered, and the processing personnel with higher proficiency is given priority to match the gas work orders with higher emergency degree, so that the value loss is effectively controlled.

In some embodiments, the smart gas management platform may randomly combine the processing personnel of the at least one gas work order to form various work order fulfillment plans. A total fulfillment man-hour cost of the processing personnel in the randomly combined work order fulfillment plan may not exceed a preset fulfillment man-hour cost. For more information about the fulfillment man-hour cost and the preset fulfillment man-hour cost, please refer to the relevant descriptions below. The smart gas management platform may take the work order fulfillment plan with the greatest planned fulfillment value among various work order fulfillment plans as the optimal work order fulfillment plan. In some embodiments, the smart gas management platform may further determine the optimal work order fulfillment plan by performing operations 510-530.

In 510, determining whether the fulfillment man-hour cost of the i-th processing personnel is not greater than the preset fulfillment man-hour cost.

The fulfillment man-hour cost refers to a time cost for the processing personnel to fulfill the gas work order. When different processing personnel perform a certain gas work order, the corresponding fulfillment man-hour costs are different.

The smart gas management platform may determine the fulfillment man-hour cost in various ways. For example, the smart gas management platform may determine the fulfillment man-hour cost through the manual input of the gas platform working personnel.

In some embodiments, in the preset mode, the determination of the fulfillment personnel is relevant to the fulfillment man-hour cost of the processing personnel, and the fulfillment man-hour cost is relevant to the proficiency degree of processing personnel and a gas demand fulfillment difficulty.

The gas demand fulfillment difficulty refers to a parameter that indicates the degree of difficulty of fulfilling the gas service demand in the gas work order. In some embodiments, the gas demand fulfillment difficulty may be indicated by a quantitative indicator. For example, the gas demand fulfillment difficulty may be indicated by a number between 1-10, and the greater the number is, the more difficult it is to fulfill the gas demand. The gas demand fulfillment difficulty may further be expressed in other ways.

In some embodiments, the smart gas management platform may obtain the gas demand fulfillment difficulty in the following manner: constructing a demand information vector based on the demand information; determining, based on the demand information vector, at least one demand information reference vector through a vector database, a similarity between the at least one demand information reference vector and the demand information vector satisfying a preset condition; and determining the gas demand fulfillment difficulty based on a fault point count and a maintenance complexity degree of a fault point of the at least one demand information reference vector.

The demand information vector refers to a vector constructed according to the demand information. The demand information reference vector refers to a vector whose similarity with the demand information vector satisfies a preset condition among historical demand information vectors. The historical demand information vector may be a vector constructed based on demand information of historical gas work orders with high user feedback satisfaction. The similarity refers to the degree of similarity between the demand information vector and the demand information reference vector.

In some embodiments, the smart gas management platform may calculate a distance between the demand information vector and the demand information reference vector, and determine the similarity based on the vector distance. An exemplary vector distance may include a cosine distance, a Euclidean distance, a Hamming distance, etc. The preset condition refers to a preset condition for determining the demand information reference vector, which may be set according to experience. For example, the preset condition may be that the similarity between the demand information vector and the demand information reference vector needs to be smaller than a certain threshold. In some embodiments, the smart gas management platform may use the historical demand information vector whose similarity with the demand information vector satisfies a preset condition as the demand information reference vector.

The fault point count refers to a count of gas fault points that need to be maintained. In some embodiments, the smart gas management platform may obtain the fault point count based on a monitoring device, a pressure sensor, etc., in the smart gas object platform.

The maintenance complexity degree of the fault point refers to a parameter representing a maintenance complexity degree of the gas fault point. In some embodiments, the maintenance complexity degree of the fault point may be represented by a quantitative index. For example, the maintenance complexity degree of the fault point may be represented by a number between 1-10, and the greater the number is, the higher the maintenance complexity degree of the fault point is. The maintenance complexity degree of the fault point may further be represented in other ways.

In some embodiments, the maintenance complexity degree of the fault point may be determined in various ways, for example, the maintenance complexity degree of the fault point may be determined through a manual input.

In some embodiments, the maintenance complexity degree of the fault point may be determined based on at least one of a maintenance material quantity used in maintenance, a maintenance material type, and an information adequacy.

The maintenance material quantity refers to a total quantity of materials used for the maintenance. For example, the maintenance material quantity may be a maintenance vehicle, a maintenance tool box, etc.

The maintenance material type refers to a type of material used for the maintenance. For example, the maintenance material type may be maintenance accessories, auxiliary materials, maintenance tools, etc.

In some embodiments, the greater the maintenance material quantity is, the greater the count of the maintenance material types is, the lower the information adequacy is, and the higher the maintenance complexity degree is. For more information on the information adequacy, please refer to FIG. 3 and the relevant descriptions.

In some embodiments of the present disclosure, the smart gas management platform may determine the maintenance complexity degree of the fault point based on at least one of the maintenance material quantity used in maintenance, the maintenance material type, and the information adequacy. The influence of multiple factors such as the maintenance material quantity, etc., on the maintenance complexity degree may be considered at the same time to obtain an accurate and reasonable maintenance complexity degree.

In some embodiments, the smart gas management platform may perform a weighted calculation on the fault point count of the demand information reference vector and the maintenance complexity degree of the fault points, and determine the result as the gas demand fulfillment difficulty of the gas work order. The weight may be determined empirically. Exemplarily, there are 3 demand information reference vectors whose similarity meets the preset condition, including 5 fault points in total, and the maintenance complexity degree of each point is 4, 8, 5, 3, 5 respectively, with an average value of 5, the weight of the fault point count is 0.2, and the weight of the maintenance complexity degree of the fault point is 0.8, then the smart gas management platform may determine that the gas demand fulfillment difficulty of the gas work order is 5.

In some embodiments, the fulfillment man-hour cost is relevant to the proficiency degree of the processing personnel and the gas demand fulfillment difficulty. The lower the proficiency of the process personnel is and the higher the gas demand fulfillment difficulty is, the higher the fulfillment man-hour cost is. The smart gas management platform may determine the processing personnel with a low fulfillment man-hour cost as the fulfillment personnel. For more information on the proficiency degree of the processing personnel, please refer to FIG. 2 and the relevant descriptions.

By setting the determination of the fulfillment personnel in the preset mode relevant to the fulfillment man-hour cost of the processing personnel, and the fulfillment man-hour cost relevant to the proficiency degree of the processing personnel and the gas demand fulfillment difficulty, it is possible to match more suitable fulfillment personnel for the gas work order, thereby avoiding a waste of the fulfillment man-hour cost due to an insufficient proficiency degree of the processing personnel or the gas demand fulfillment difficulty exceeding an ability of the processing personnel.

The preset fulfillment man-hour cost refers to the fulfillment man-hour cost set in advance. The preset fulfillment man-hour cost may be any value less than or equal to a remained total disposable fulfillment man-hour cost of the processing personnel. For example, when selecting the i-th processing person, the remained total disposable fulfillment man-hour cost of the processing person is 100 hours, and the preset fulfillment man-hour cost may be any value less than or equal to 100 hours.

In some embodiments, the smart gas management platform may determine the preset fulfillment man-hour cost based on a fourth preset rule. The fourth preset rule may be the preset rule on how to determine the preset fulfillment man-hour cost. For example, the fourth preset rule may calculate the remained total disposable fulfillment man-hour cost of the processing personnel as the preset fulfillment man-hour cost. Exemplarily, the preset fulfillment man-hour cost may be indicated by w, w=wₙ−Σwₓ, where, wₙ indicates the total disposable fulfillment man-hour cost of the processing personnel, and Σwₓ, indicates a sum of the required fulfillment man-hour cost of the processing personnel selected from the nth to (i+1)th processing personnel.

In some embodiments, the smart gas management platform may determine whether the fulfillment man-hour cost of the i-th processing personnel is not greater than the preset fulfillment man-hour cost by making a difference. For example, the smart gas management platform may make a difference between the fulfillment man-hour cost of the i-th processing personnel and the preset fulfillment man-hour cost, if the difference of “the fulfillment man-hour cost—the preset fulfillment man-hour cost” is greater than 0, then the fulfillment man-hour cost of the i-th processing personnel is greater than the preset fulfillment man-hour cost. If the difference is less than or equal to 0, the fulfillment man-hour cost of the i-th processing personnel is not greater than the preset fulfillment man-hour cost.

In 520, in response to that the fulfillment man-hour cost of the i-th processing personnel is not greater than the preset fulfillment man-hour cost, determining, based on a comparison between a first fulfillment value and a second fulfillment value, optimal work order fulfillment plans corresponding to the previous i processing personnel and planned fulfillment values of the previous i processing personnel.

The first fulfillment value refers to a total fulfillment value of the optimal work order fulfillment plans on the premise that the i-th processing personnel is not included. For example, when the current processing personnel is the 10th personnel, the first fulfillment value is the total fulfillment value of the optimal work order fulfillment plans that does not include the 10th processing personnel, that is, only the previous 9 processing personnel are considered.

In some embodiments, the first fulfillment value may be determined based on the optimal work order fulfillment plans that does not include the i-th processing personnel.

In some embodiments, the first fulfillment value may be represented by a formula (1):

f₁=f(i−1,w) (1)

where, f(i−1, w) indicates the fulfillment value of the optimal work order fulfillment plans of the previous i−1 processing personnel under the condition of an available man-hour fulfillment cost w (at this time, the available man-hour fulfillment cost is the same as the preset man-hour fulfillment cost).

In some embodiments, the smart gas management platform may determine the optimal work order fulfillment plan of the previous i−1 processing personnel excluding the i-th processing personnel, and calculate the fulfillment value of the optimal work order fulfillment plan of the previous i−1 processing personnel as the first fulfillment value.

The second fulfillment value refers to the total fulfillment value of a reference work order fulfillment plan of the i-th processing personnel and the previous i−1 processing personnel when the i-th processing personnel is included. For example, when the current processing personnel is the tenth personnel, the second fulfillment value is the total fulfillment value of the reference work order fulfillment plan of the tenth processing personnel and the previous nine processing personnel.

In some embodiments, the second fulfillment value may be determined based on a value influence of the i-th processing personnel and the reference work order fulfillment plan corresponding to the previous i−1 processing personnel, and a plan man-hour of the reference work order fulfillment plan is relevant to the fulfillment man-hour cost of the i processing personnel.

The reference work order fulfillment plan refers to a feasible processing personnel selection plan from the i−1th processing personnel to the first processing personnel. For example, the reference work order fulfillment plan may be the work order fulfillment plan with the greatest value of the previous i−1 processing personnel under the condition of the plan man-hour.

The plan man-hour is the remained fulfillment man-hour cost after the i-th processing person is selected. For example, a preset fulfillment man-hour cost is 200 hours, and the fulfillment man-hour cost of the i-th processing personnel is 40 hours, then the plan man-hour of the reference work order fulfillment plan is 160 hours.

In some embodiments, the smart gas management platform may calculate the difference between the fulfillment man-hour cost and the fulfillment man-hour cost of the i-th processing personnel, and determine the difference as the plan man-hour of the reference work order fulfillment plan.

In some embodiments, the second fulfillment value may be represented by formula (2):

f₂=f(i−1,w−wᵢ)+vᵢ (2)

where, f(i−1, w−wᵢ) indicates the greatest value brought by fulfilling the reference work order fulfillment plans of the previous i−1 processing personnel under the condition of the available fulfillment man-hour cost w−wᵢ (at this time, the available fulfillment man-hour cost is equal to the preset fulfillment man-hour cost minus the fulfillment man-hour cost of the i-th processing personnel), wᵢ indicates the fulfillment man-hour cost of the i-th processing personnel, and vᵢ indicates the fulfillment value of the i-th processing personnel.

In some embodiments, the smart gas management platform may determine the reference work order fulfillment plan of the previous i−1 processing personnel under the premise of selecting the i-th processing personnel, and calculate the total fulfillment value of the reference work order fulfillment plans of the i-th processing personnel and the previous i-th processing personnel as a second value.

The planned fulfillment value refers to the total fulfillment value of the optimal fulfillment personnel selected according to the optimal work order fulfillment plan. For example, the total benefit brought after all the processing personnel in the optimal work order fulfillment plan are selected.

In some embodiments, the smart gas management platform may compare the first fulfillment value with the second fulfillment value, and use the greater one as the planned fulfillment value. The planned fulfillment value may be expressed by formula (3):

$$f ( i , w ) = max ( {f}_{1} , {f}_{2} ) \qquad ( 3 )$$

$$= max ( f ( i - 1 , w ) , f ( i - 1 , w - {w}_{i} ) + {v}_{i} )$$

where, f(i−1, w) and f(i−1, w−wᵢ) may be determined by performing operations 510 to 530 after determining a size relationship between the fulfillment man-hour cost of the (i−1)th processing personnel and the corresponding preset fulfillment man-hour cost or available fulfillment man-hour cost. For example, when the fulfillment man-hour cost of the (i−1)th processing personnel is not greater than the corresponding preset fulfillment man-hour cost, f(i−1, w)=max(f(−2, wᵢ₋₁), f(i−2, wᵢ₋₁−wᵢ₋₂) vᵢ₋₁), where wᵢ₋₁ indicates the preset fulfillment man-hour cost corresponding to the (i−1)th processing personnel, and wᵢ₋₂ indicates the fulfillment man-hour cost of the (i−2)th processing personnel, vᵢ₋₁ indicates the fulfillment value of the i-th processing personnel. The smart gas management platform may perform a recursion according to the above-mentioned manner until the planned fulfillment value f(i, w) is determined.

The smart gas management platform may determine at least one processing personnel in a candidate work order fulfillment plan corresponding to the planned fulfillment value as at least one optimal fulfillment person.

In 530, in response to that the fulfillment man-hour cost of the i-th processing personnel is greater than the preset fulfillment man-hour cost, determining, based on the reference work order fulfillment plan corresponding to the previous i−1 processing personnel, the optimal work order fulfillment plan corresponding to the previous i processing personnel and their planned fulfillment values.

In some embodiments, the smart gas management platform may determine a maximum value corresponding to the previous i−1 processing personnel under the condition of the available fulfillment man-hour cost w (at this time, the available fulfillment man-hour cost is equal to the preset fulfillment man-hour cost), and take the maximum value as the planning fulfillment value. The maximum value of the previous i−1 processing personnel may be determined by performing operations 510-530 when i=i−1. For example, a relationship between the i−1th processing person and the corresponding preset fulfillment man-hour cost may be determined; when the fulfillment man-hour cost of the i−1th processing person is not greater than the corresponding preset fulfillment man-hour cost, a recursion may be performed following the formula (3) and the relevant descriptions to determine the planned fulfillment value.

Determining the optimal fulfillment personnel based on the optimal work order fulfillment plan may maximize the value of the fulfillment of the work order fulfillment plan matched with the gas work order, and ensure an efficiency and accuracy of the fulfillment personnel determination.

Through determining, based on the demand information and the personnel information of the gas platform, the fulfillment personnel through the preset method, the fulfillment personnel matching the gas work order may be more accurately and reasonably determined, so as to ensure a timeliness and effectiveness of the gas work order processing and improve the user's gas service experience.

The present disclosure also provides a computer-read able storage medium, which stores computer instructions. After the computer reads the computer instructions in the storage medium, the computer executes the platform based on smart gas operation as described in any one of the above-mentioned embodiments. The work order fulfillment mode.

The basic concept has been described above, obviously, for those skilled in the art, the above detailed disclosure is only an example, and does not constitute a limitation to this description. Although not expressly stated here, those skilled in the art may make various modifications, improvements, and corrections to this description. These alterations, improvements, and modifications are intended to be suggested by this disclosure and are within the spirit and scope of the exemplary embodiments of this disclosure.

In closing, it is to be understood that the embodiments of the application disclosed herein are illustrative of the principles of the embodiments of the application. Other deformations are also possible within the scope of the present disclosure. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for smart gas platform work order fulfillment, wherein the method is executed through a smart gas management platform of an Internet of things (IoT) system for smart gas platform work order fulfillment, and the method comprises:
obtaining demand information of at least one gas work order of a gas platform, wherein the demand information includes at least one of a demand type, a work order creation time, detection data, a gas component aging degree, gas user feedback information, user information, a demand location, and a demand status;
determining, based on the demand information, a fulfillment mode of the at least one gas work order, wherein the fulfillment mode at least includes self-service fulfillment and manual fulfillment, and the manual fulfillment includes at least one of immediate manual fulfillment and manual fulfillment after supplementing information; and
in response to that the fulfillment mode is the manual fulfillment, determining a work order fulfillment plan of the at least one gas work order based on the demand information and personnel information of the gas platform, wherein the work order fulfillment plan includes a fulfillment time limit and fulfillment personnel.

2. The method of claim 1, wherein the IoT system for smart gas platform work order fulfillment further includes: a smart gas user platform, a smart gas service platform, a smart gas sensor network platform, and a smart gas object platform;
the smart gas object platform is configured to obtain at least one of the detection data and the gas component aging degree, and transmit the at least one of the detection data and the gas component aging degree to the smart gas management platform through the smart gas sensor network platform; and
the smart gas user platform is configured to obtain at least one of the demand type, the work order creation time, the gas user feedback information, the user information, the demand location, and the demand status, and transmit the at least one of the demand type, the work order creation time, the gas user feedback information, the user information, the demand location, and the demand status to the smart gas management platform through the smart gas sensor network platform.

3. The method of claim 1, wherein the determining, based on the demand information, a fulfillment mode of the at least one gas work order includes:
determining, based on the demand information, an emergency degree of the at least one gas work order; and
determining, based on the emergency degree, the fulfillment mode.

4. The method of claim 1, further comprising:
in response to that the fulfillment mode is the manual fulfillment, determining that the at least one gas work order adopts the immediate manual fulfillment or the manual fulfillment after supplementing information based on an information adequacy.

5. The method of claim 4, wherein the information adequacy is relevant to a correction coefficient, and the correction coefficient is determined based on a gas pipeline network complexity.

6. The method of claim 1, wherein the determining a work order fulfillment plan of the at least one gas work order based on the demand information and personnel information of the gas platform includes:
determining a gas pipeline network complexity based on a pipeline branch point count, a gas user type, a gas user count, and a pipeline density of a gas pipeline network of an area where the demand location is located; and
determining the fulfillment time limit based on the demand type, the detection data, the gas component aging degree, the user information, and the gas pipeline network complexity, wherein the fulfillment time limit includes at least one of a latest start time and a latest completion time of the at least one gas work order, and the user information includes at least one of the gas user type, a gas customer count, and a gas customer feature.

7. The method of claim 6, wherein the determining the fulfillment time limit based on the demand type, the detection data, the gas component aging degree, the user information, and the gas pipeline network complexity includes:
determining the fulfillment time limit through a fulfillment time limit prediction model based on the demand type, the detection data, the gas component aging degree, the user information, and the gas pipeline network complexity, wherein the fulfillment time limit prediction model is a machine learning model.

8. The method of claim 7, wherein an input of the fulfillment time limit prediction model includes an emergency degree of the at least one gas work order.

9. The method of claim 8, wherein the fulfillment time limit prediction model includes a value loss layer and a fulfillment time limit prediction layer, and the method further comprises:
determining, based on the demand information and the emergency degree, a value loss of the at least one gas work order through the value loss layer, wherein the value loss layer is a machine learning model; and
determining, based on the value loss, the demand type, the detection data, the gas component aging degree, the user information, and the gas pipeline network complexity, the fulfillment time limit through the fulfillment time limit prediction layer, wherein the fulfillment time limit prediction layer is a machine learning model.

10. The method of claim 1, wherein the determining a work order fulfillment plan of the at least one gas work order based on the demand information and personnel information of the gas platform includes:
determining the fulfillment personnel based on the demand information and the personnel information of the gas platform, the fulfillment personnel including at least one of a fulfillment individual and a fulfillment team who fulfill the at least one gas work order, the personnel information including at least one of a proficiency degree of processing personnel and pending work order information of the processing personnel, and the proficiency degree of the processing personnel being relevant to a personnel rank, a historical gas work order count corresponding to the processing personnel, and a historical gas work order type distribution.

11. The method of claim 10, wherein the determining a work order fulfillment plan of the at least one gas work order based on the demand information and personnel information of the gas platform comprises:
determining, based on the demand information and the personnel information of the gas platform, the fulfillment personnel through a preset mode.

12. The method of claim 11, wherein in the preset mode, a determination of the fulfillment personnel is relevant to a fulfillment value of the processing personnel, and the fulfillment value is relevant to the proficiency degree of the processing personnel, an emergency degree and a value loss of the at least one gas work order.

13. The method of claim 11, wherein in the preset mode, a determination of the fulfillment personnel is relevant to a fulfillment man-hour cost of the processing personnel, and the fulfillment man-hour cost is relevant to the proficiency degree of the processing personnel and a gas demand fulfillment difficulty; and
wherein, the gas demand fulfillment difficulty is obtained in a way including:
constructing, based on the demand information, a demand information vector;
determining, based on the demand information vector, at least one demand information reference vector through a vector database, wherein a similarity between the at least one demand information reference vector and the demand information vector satisfies a preset condition; and
determining the gas demand fulfillment difficulty based on a fault point count and a maintenance complexity degree of a fault point of the at least one demand information reference vector.

14. The method of claim 13, wherein the maintenance complexity degree of the fault point is determined based on at least one of a maintenance material quantity used in maintenance, a maintenance material type, and an information adequacy.

15. An Internet of things (IoT) system for smart gas platform work order fulfillment, wherein a smart gas management platform of the IoT system is configured to:
obtain demand information of at least one gas work order of a gas platform, wherein the demand information includes at least one of a demand type, a work order creation time, detection data, a gas component aging degree, gas user feedback information, user information, a demand location and a demand status;
determine, based on the demand information, a fulfillment mode of the at least one gas work order, wherein the fulfillment mode at least includes a self-service fulfillment and manual fulfillment, and the manual fulfillment includes at least one of immediate manual fulfillment and manual fulfillment after supplementing information; and
in response to that the fulfillment mode is the manual fulfillment, determine a work order fulfillment plan of the at least one gas work order based on the demand information and personnel information of the gas platform, wherein the work order fulfillment plan includes a fulfillment time limit and a fulfillment personnel.

16. The IoT system of claim 15, wherein the IoT system further includes: a smart gas user platform, a smart gas service platform, and a smart gas sensor network platform and smart gas object platform;
the smart gas object platform being configured to obtain at least one of the detection data and the gas component aging degree, and transmit the at least one of the detection data and the gas component aging degree to the smart gas management platform through the smart gas sensor network platform; and
the smart gas user platform being configured to obtain at least one of the demand type, the work order creation time, the gas user feedback information, the user information, the demand location, and the demand status, and transmit the at least one of the demand type, the work order creation time, the gas user feedback information, the user information, the demand location, and the demand status to the smart gas management platform through the smart gas sensor network platform.

17. The IoT system of claim 15, wherein the smart gas management platform is further configured to:
determine, based on the demand information, an emergency degree of the at least one gas work order gas work order; and
determine, based on the emergency degree, the fulfillment mode.

18. The IoT system of claim 15, wherein the smart gas management platform is further configured to:
determine a gas pipeline network complexity based on a pipeline branch point count, a gas user type, a gas user count, and a pipeline density of a gas pipeline network of an area where the demand location is located; and
determine the fulfillment time limit based on the demand type, the detection data, the gas component aging degree, the user information and the gas pipeline network complexity, wherein the fulfillment time limit includes at least one of a latest start time and a latest completion time of the at least one gas work order, and the user information includes at least one of the gas user type, a gas customer count, and a gas customer feature.

19. The IoT system of claim 15, wherein the smart gas management platform is further configured to:
determine the fulfillment personnel based on the demand information and the personnel information of the gas platform, the fulfillment personnel including at least one of a fulfillment individual and a fulfillment team who fulfill the at least one gas work order, the personnel information including at least one of a proficiency degree of processing personnel and pending work order information of the processing personnel, and the proficiency degree of the processing personnel being relevant to a personnel rank, a historical gas work order count corresponding to the processing personnel, and a historical gas work order type distribution.

20. A non-transitory computer-readable storage medium storing computer instructions, wherein when reading the computer instructions in the storage medium, a computer implements the method for smart gas platform work order fulfillment according to claim 1.
